(19) United States
(12) Patent Application Publication
(10) Pub. No.: US 2014/0196429 A1
(43) Pub. Date: Jul. 17, 2014

(54) HAYMAKING MACHINE COMPRISING AN IMPROVED DEFLECTOR

(71) Applicant: Kuhn S.A., Saverne (FR)

(72) Inventor: Christian GANTZER, Woustwiller (FR)

(73) Assignee: Kuhn S.A., Saverne (FR)

(21) Appl. No.: 14/107,385

(22) Filed: Dec. 16, 2013

(30) Foreign Application Priority Data
Jan. 17, 2013 (FR) 13 50393

(51) Int. Cl. A01D 78/02; A01B 73/02

(52) U.S. Cl. CPC A01D 78/02; A01B 73/02
USPC 56/377

(57) ABSTRACT

A haymaking machine comprises a harvesting device comprising a rotor driven about an axis which is horizontal and perpendicular to a direction of advance during work, teeth, the points of which describe a curve envelope when the rotor turns about the axis, and a conveyor moving the plants transversely to the direction of advance, the machine comprising a deflector connected to an arm connected to the harvesting device by means of an articulation, about which the arm can pivot between a first position in which the deflector is arranged, during work, beside and at a distance from a lateral end of the harvesting device, and a second position. In the second position and considering the machine during work, the deflector and the arm extend flat and at least partially above the harvesting device.

### BACKGROUND OF THE INVENTION

1. Field of the Invention

The present invention relates to a haymaking machine comprising at least one plant pick-up and moving device, comprising a rotor able to be driven about a rotation axis which is substantially horizontal and substantially perpendicular to a direction of advance of the machine in a work position, teeth with teeth points describing a curve envelope when the rotor is driven about the rotation axis, and a conveyor which moves the plants transversely to the direction of advance, the machine also comprising at least one deflector which cooperates with the pick-up and moving device so as to receive, during work, a flow of plants moved by the conveyor so as to form a windrow, the deflector being connected to an arm which is itself connected, by means of a first articulation device, to the pick-up and moving device, by means of which first articulation device the arm can be pivoted, with respect to the pick-up and moving device, between a first position in which the deflector is arranged, in the work position of the machine, beside a lateral end of the pick-up and moving device and is remote from the lateral end, and a second position.

2. Discussion of the Background

A first machine of this type is known from the document U.S. Pat. No. 4,748,803. It is a trailed machine which can be coupled to the rear of a tractor and comprising a chassis, the rear part of which rests on the ground by means of wheels. Between the latter, a pick-up and moving device extends, comprising a pick-up member of the pick-up type and a conveyor placed backwards of the pick-up, viewed in a direction of advance of the machine. The pick-up and moving device remains substantially parallel to the ground, whether the machine is in a work position or in a transport position. An arm carrying a deflector is articulated on the chassis by means of a vertical pivot placed at the rear of the conveyor. In a first position of the arm used for work, the deflector extends by some distance from a lateral side of the conveyor. The deflector then receives the plants which are moved laterally by the conveyor, so as to form a windrow. In a second position of the arm used for the transport of the machine, the arm is pivoted towards the rear about the vertical pivot. In this second position, the deflector extends at the rear of the pick-up and moving device and at the rear of the chassis, and therefore comes to significantly increase the longitudinal overall dimension of the machine. This design does not permit a compact machine to be obtained for transport. In addition, in this second position of the arm, the deflector projecting at the rear of the chassis is greatly exposed to impacts.

A second machine is known from the document FR 2 678 804. It is a windrower, the pick-up and moving device of which comprises a toothed rotor which can be driven about a vertical rotation axis. This rotor rests on the ground by means of a train of wheels placed beneath the rotor. This rotor is carried by a frame designed to be coupled to a tractor such that during work, the frame is lowered so that the wheels rest on the ground, whilst for transport in particular, the frame is raised, with the train of wheels remaining substantially parallel to the ground. Articulated on the frame is an end of a telescopic arm carrying at its other end a deflector for forming a windrow. In a first position of the arm, used for work, the deflector extends vertically on a lateral side of the rotor and at some distance therefrom. In a second position of the arm, used for the transport of the machine, the arm is folded to the vertical such that the deflector extends substantially to the horizontal above the frame at a distance therefrom close to the length of the arm. Thus, the vertical overall dimension of the machine is great when the arm is in the second position. The centre of gravity of the machine is therefore higher, to the detriment of the stability of the machine, in particular during transport. Furthermore, a design of the deflector and of the arm, in accordance with that of the second known machine is difficult to apply on a haymaking machine according to the invention. In fact, this latter frequently comprises several pick-up and moving devices, each comprising a horizontal rotor and a conveyor placed downstream, with a view to obtaining a large working width, comprised, for example, between six and twelve metres. So as to comply with the standards of overall dimensions for road movements, the pick-up and moving devices, placed laterally with respect to the chassis of the machine, are folded upwards for transport, in a generally substantially vertical position, even beyond the vertical. The use of a deflector and of an arm according to those of the second known machine, carried by a frame of one of these lateral pick-up and moving devices, would pose a problem with regard to overall dimension when the arm is placed in the second position above the device and the latter is folded upwards with respect to the chassis. In this case, in fact, the overall dimension of the device would be great in a direction perpendicular to the direction of advance of the machine. In the case of pick-up and moving devices arranged, during work, substantially side by side, on either side of the chassis, the total width of the machine would then be great in the upward folded position of the devices. A reduction of this total width could be obtained by means of an offsetting of the pick-up and moving devices in the direction of advance. This would nevertheless lead to a significant increase in the longitudinal overall dimension of the machine. Elaborate kinematics for folding the pick-up and moving devices upwards could be envisaged to compensate for the overall dimension of the deflector and of the arm in the second position, at the cost, however, of a very complex and costly machine.

### SUMMARY OF THE INVENTION

The present invention has the aim of proposing a haymaking machine which does not present the above-mentioned drawbacks. The machine according to the invention makes is possible to form a regular and readily delimited windrow. In addition, it is capable of having a large working width whilst maintaining, for manoeuvres and for transport, a reduced overall dimension and a low centre of gravity, favourable to stability. Finally, the invention has recourse to technical means which are relatively simple and not very expensive.

To this end, an important feature of the invention consists in that, in the second position of the arm and considering the machine in the work position, the deflector and the arm extend substantially flat and at least partially above the pick-up and moving device.

The machine according to the invention can comprise a single pick-up and moving device carried by a frame. In this case, in the work position and in the transport position of the machine, the frame rests on the ground by means of wheels, whilst the pick-up and moving device extends substantially parallel to the ground. The machine according to the invention thus has a reduced height and a low centre of gravity in the second position of the arm. In this second position, the arm and the deflector are not much exposed to the possible impacts with obstacles on the sides or at the rear of the machine. In addition, an increase in the length of the machine can be avoided when the arm is moved from the first position towards the second, hence a preserved manoeuvrability.

The machine according to the invention can also comprise several pick-up and moving devices connected to a central chassis, in particular two lateral devices or else a central device supplemented by two lateral devices. These devices are, for example, aligned one beside the other in the work position of the machine. In the transport position or for manoeuvres, the lateral devices are folded upwards. The invention makes it possible to operate this upward folding without risk of seeing the deflector and/or the arm come into collision with an adjacent pick-up and moving device, or else with the central chassis. In this way, the lateral pick-up and moving devices can be brought very close one towards the other, or towards the central chassis, with a view to obtaining a reduced width and/or height in the transport position of the machine.

### BRIEF DESCRIPTION OF THE DRAWINGS

Other features and advantages of the invention will emerge from the following description with reference to the attached drawings which represent a non-restrictive example embodiment of the machine according to the invention.

In these drawings:

FIG. 1 represents a perspective view of an example embodiment of a machine according to the invention, in a first orientation;

FIG. 2 represents a perspective view of the example embodiment in a second orientation;

FIG. 3 represents a perspective view of a portion of the example embodiment, in the first position of the arm;

FIG. 4 represents a perspective view of a portion of the example embodiment in the second position of the arm;

FIG. 5 represents a perspective view of a portion of the example embodiment in a position of the arm situated between the first and second positions;

FIG. 6 represents a perspective view of a portion of the example embodiment, the arm being in the first position and the deflector partially folded.

### DESCRIPTION OF THE PREFERRED EMBODIMENT

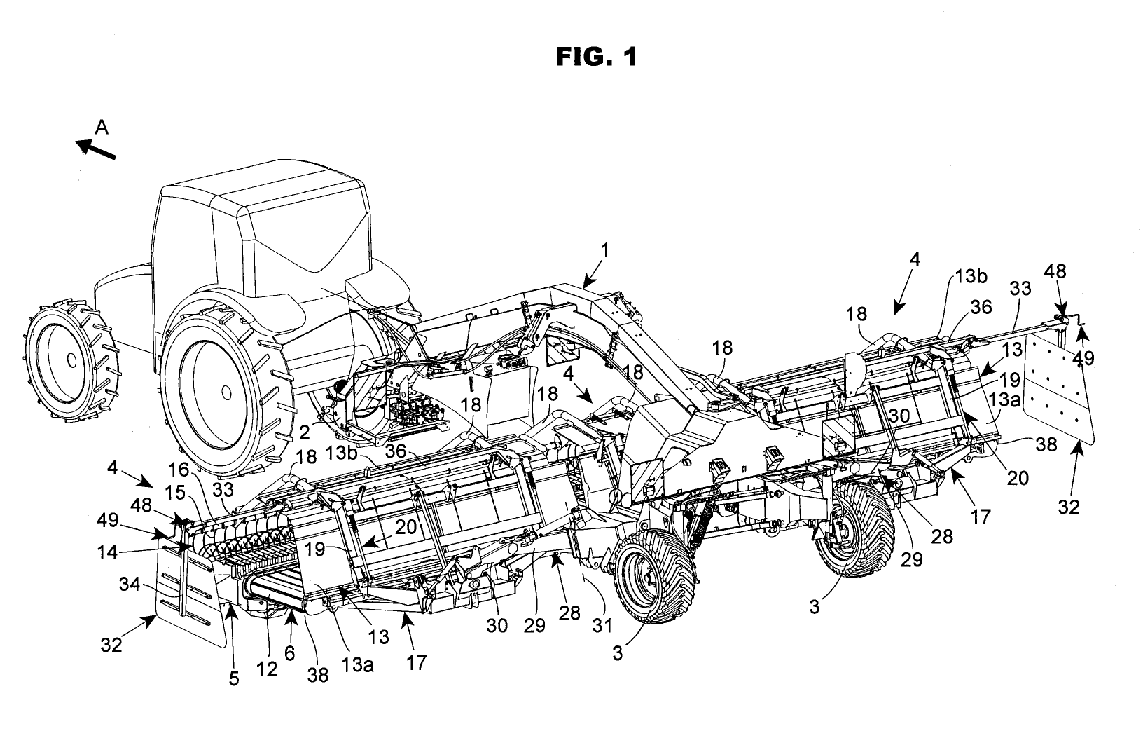

The agricultural machine according to the invention illustrated in FIG. 1 comprises a chassis 1. This chassis 1 comprises a more or less central longitudinal beam. The latter carries at its front end a hitching device 2. The latter enables the connection of the chassis 1 to a tractor so as to move the machine in a direction of advance A. A power take-off of the tractor provides the driving of the different work elements of the machine. The rear part of the chassis 1 comprises a train of wheels 3 in contact with the ground. In the following description, the terms “left”, “right”, “front”, “rear”, “rearwards”, “back” and “posterior” relate to the direction of advance A, and the terms “upper”, “upwards” and “above” are defined with respect to the ground.

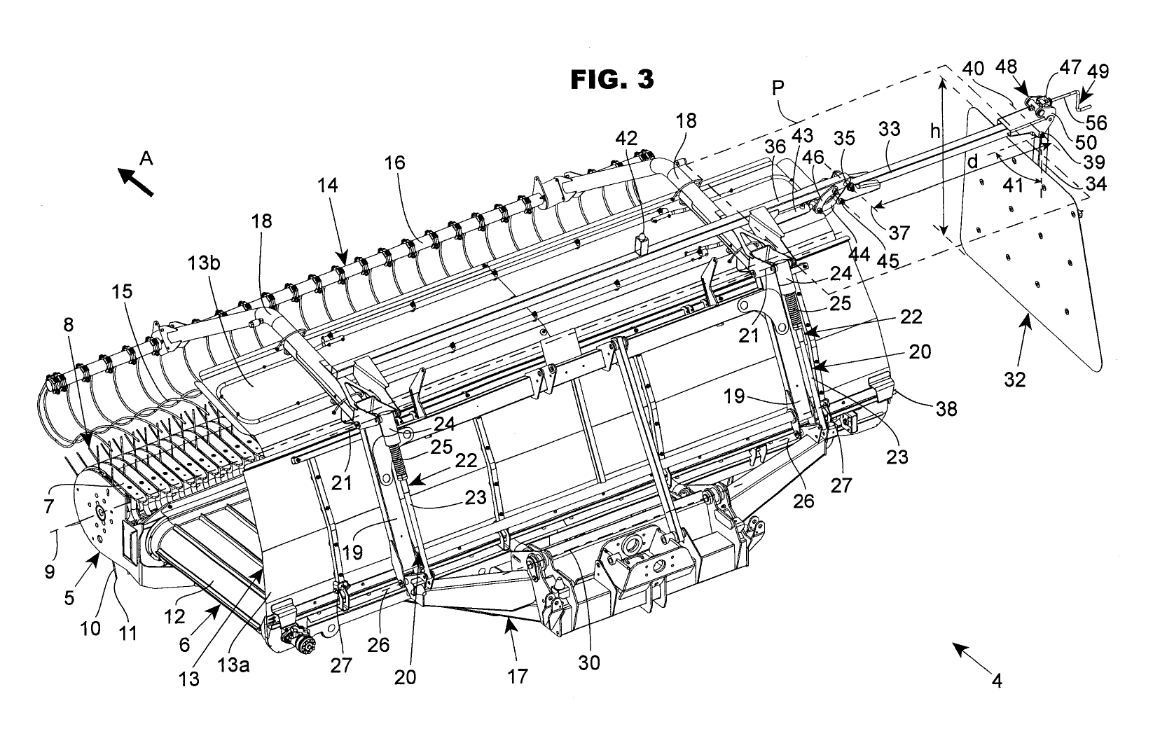

The machine comprises at least one plant pick-up and moving device 4. As can be seen from FIG. 1, this pick-up and moving device 4 is situated, relative to the direction of advance A, between the hitching device 2 and the train of wheels 3. The pick-up and moving device 4 comprises a pick-up element 5 and a moving element 6. As illustrated in particular in FIG. 3, the pick-up element 5 comprises a curved guiding surface 7 and a rotor 8. The rotor 8 can be driven about a rotation axis 9 in anti-clockwise direction, viewed from the right of the pick-up and moving device 4. In a work position of the machine, this rotation axis 9 is substantially horizontal and substantially perpendicular to the direction of advance A. The pick-up element 5 also comprises teeth 10 which pick up the plants at the level of the ground, lift them and project them towards the rear. The teeth 10 comprise teeth points 11 which describe a curve envelope when the rotor 8 is driven about the rotation axis 9. The teeth 10 emerge at least partially from the guiding surface 7. In the example embodiment of the figures, the pick-up element 5 is of the pick-up type, the teeth 10 of which are carried by the rotor 8 and emerge from the guiding surface 7 formed by a large number of curved blades about the rotor 8 and placed one beside the other along the rotation axis 9. The teeth 10 move between these blades. In this example embodiment, the guiding surface 7 is fixed. The teeth 10 are controlled such that the curve envelope described by the movement of the teeth points 11 is not cylindrical. In fact, the teeth 10 retract inside the guiding surface 7 when they approach an upper and posterior end of the guiding surface 7. In this way, the teeth 10 progressively release the plants which approach the moving element 6. Such a movement of the teeth 10 is obtained by means, for example, of a fixed cam track inside which rollers move which are carried by cams connected to the teeth 10. Alternatively, teeth 10 which are not controlled can also be envisaged. In this case, the curve envelope described by the teeth points 11 is a cylinder centred on the rotation axis 9 of the rotor 8. Other embodiments of the pick-up element 5, which are not represented, remain possible. The latter can thus comprise a flexible belt wound around a first rotor placed at the front of the pick-up element 5 and about a second rotor placed more to the rear. In particular this second rotor can be placed in the work position of the machine, at a greater distance from the ground than the first rotor, such that the pick-up element 5 moves the plants towards the rear and upwards in the direction of the moving element 6. Such a belt comprises teeth, forks or hooks which can be fixed or articulated on the belt. In this embodiment, the guiding surface 7 is constituted by the surface of the belt in contact with the plants. In this case, the guiding surface 7 is driven. The rotation axis 9 of the rotor 8 is that of the first rotor.

The driving of the pick-up element 5 is realized by means of any suitable element. It can be a hydraulic or electric motor, which motor can be housed inside of the rotor 8 or else projects laterally therefrom. The pick-up element 5 can also be driven by means of a chain or a belt, or else by a geartrain. A combination of such means is also possible.

The moving element 6 for the picked up plants is situated at the rear and close to the pick-up element 5 such that it receives the plants projected towards the rear by the latter. This moving element 6 comprises a conveyor 12 which moves the plants transversely to the direction of advance A. In the example embodiment of the figures, the conveyor 12 is a belt conveyor. This belt is wound around two cylinders placed at the lateral ends of the conveyor 12, between which cylinders a conveying surface of the belt extends in contact with the plants. These cylinders can turn around axes oriented, in the work position of the machine, substantially in the direction of advance A. At least one of these cylinders is driven during work such that the plants received from the pick-up element 5 are redeposited on the ground in the form of a windrow with a view to their being subsequently taken up again. On the rear side of the moving element 6 a wall 13 is arranged, which comprises a substantially vertical portion 13a to limit the projection towards the rear of the plants.

The wall 13 can also comprise another substantially horizontal portion 13b, to limit the projections of plants upwards. As can be seen in particular from FIGS. 1 and 3, this other portion 13b is placed in the continuity of the substantially vertical portion, above the belt conveyor 12.

The moving element 6 can also be a roller conveyor, these latter being mounted for example on rotation axes oriented, in the work position of the machine, substantially in the direction of advance A. Such rollers are preferably placed one beside the other and at a slight distance from one another, and can be driven such that the plants are moved transversely to the direction of advance A.

The driving of the moving element 6, for example of the belt- or roller conveyor 12, is carried out by means of any suitable element. It can be a hydraulic or electric motor. A driving by means of a chain or a belt, or else by a geartrain, can also be envisaged. A combination of such means is, of course, possible. These means can be actuated in one operating direction or in the other. In particular in the case of a belt- or roller conveyor 12, the plants can be transferred in this way towards the left side or the right side of the machine, for example to form a windrow on one side or the other.

The pick-up and moving device 4 also comprises a plant guiding device 14. As can be seen in particular in FIG. 3, this guiding device 14 is situated at least partially above and at a small distance from the pick-up element 5. The guiding device 14 comprises flexible rods 15 which are substantially parallel with one another and which extend from the front of the pick-up element 5 towards the rear. During work, the plants picked up by the teeth 10 of the rotor 8 come in contact with the rods 15 and slide along the latter towards the rear. In addition, these rods 15 keep the plants in engagement with the teeth 10. The rods 15 of the guiding device 14 are fixed on a bar 16. They each comprise a spring part, formed, for example, by a winding in the form of a coil of the metal wire which composes the rod 15. Each spring part is threaded on the bar 16 and held by a bolt. Apart from a large number of juxtaposed flexible rods 15, the guiding device 14 can be formed by a curved metal sheet extending from the front of the pick-up element 5 towards the rear. A combination of flexible rods 15 and of one or more metal sheets can be envisaged. The guiding device 14 can also comprise at least one front roller pivotably mounted about an axis extending, in the work position of the machine, substantially perpendicularly to the direction of advance A. This roller can turn about the said axis freely or driven by means of an actuator, such as a motor. The front end of the guiding device 14 is then constituted by the roller. Extending rearwards of the roller are, for example, flexible rods, a metal sheet, or a combination of these elements.

The pick-up and moving device 4 comprises a frame 17. The pick-up and moving device 4 also comprises two small girders 18. These small girders 18 carry the bar 16 of the guiding device 14. As can be seen from FIG. 3, they extend towards the rear above the moving element 6. The small girders 18 are connected close to their rear ends to supports 19, connected to the frame 17. The small girders 18 are, in addition, articulated on the frame 17 by means of a moving device 20. This moving device 20 comprises in particular axes 21 which are substantially parallel to the rotation axis 9 of the rotor 8. These axes 21 are carried by the supports 19. In an active configuration of the small girders 18 illustrated in particular in FIGS. 1 and 3, and used in particular in the work position of the machine, these axes 21 are positioned above the rear part of the moving element 6, and the small girders 18 are distanced from the pick-up element 5 and from the moving element 6 so as not to impede the movements of the plants. The small girders 18 can pivot upwards by a certain angle about these axes 21.

The moving device 20 comprises in addition stops 22 which limit the pivoting angle of the small girders 18 about these axes 21. Each of these stops 22 is constituted by a rod 23, one of the ends of which is articulated on the frame 17 and the other is engaged in a sleeve 24 which is articulated on the rear end of one of the small girders 18. The end engaged in the sleeve 24 is provided with a shoulder situated between two stops placed at the two ends of the sleeve 24. The stops limit the possible displacement of the sleeve 24 with respect to the shoulder of the rod 23 and consequently the pivoting angle of the small girders 18 about the axes 21. A compression spring 25 is arranged between the rod 23 and the sleeve 24 of each stop 22. This spring exerts a pressure on the corresponding sleeve 24, which tends to cause the small girders 18 and the guiding device 14 to pivot in the direction of the pick-up element 5 so as to keep the guiding device 14 in contact with the moved plants. In addition, this spring 25 damps the movements of the small girders 18 about the axes 21.

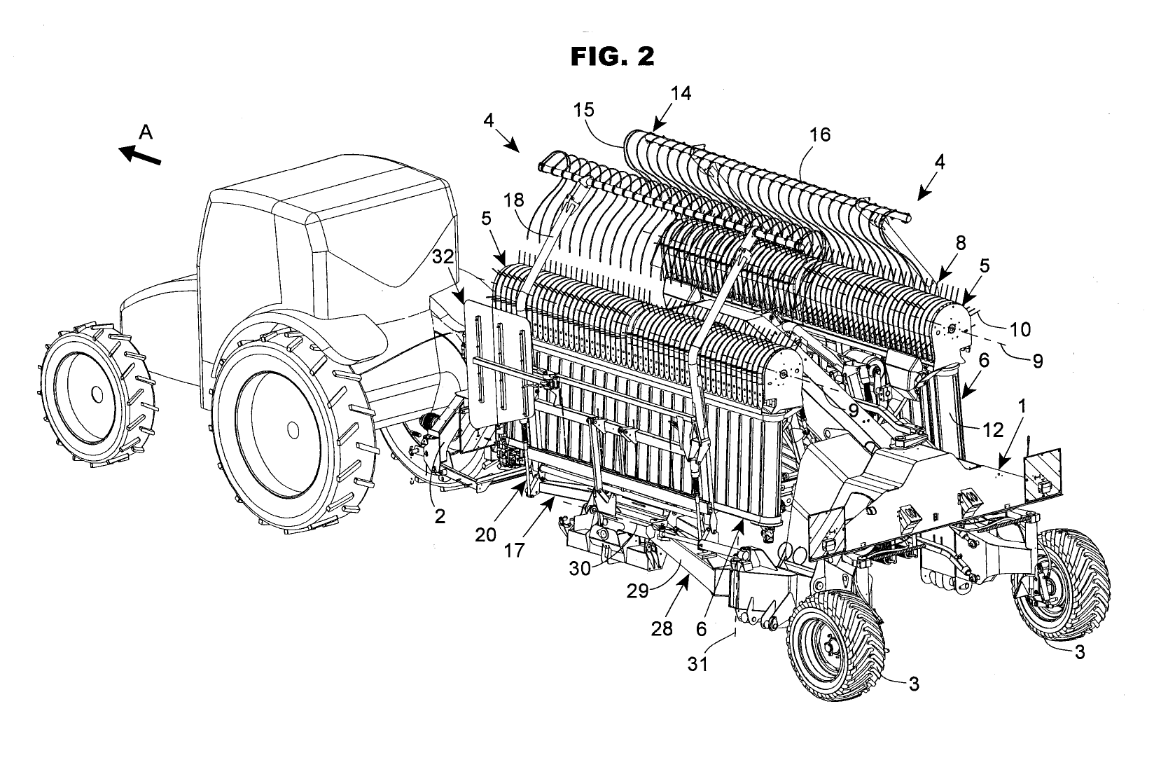

The moving device also comprises first axes 26 connecting the supports 19 of the small girders 18 to the frame 17. These first axes 26 are substantially parallel to the rotation axis 9 of the rotor 8. They are situated at the rear of the moving element 6. The supports 19, and therefore the small girders 18, can be pivoted about these first axes 26. These supports 19 thus form deformable parallelograms with the stops 22, the rear ends of the small girders 18 and parts of the frame 17. The deformation of these parallelograms induces a pivoting of the small girders 18 about the first axes 26 between the active configuration of FIGS. 1 and 3 and an inactive configuration of the small girders 18 represented in FIG. 2. The inactive configuration is used in particular in the transport position of the machine.

In the inactive configuration of the small girders 18, these latter are folded against the conveyor 12 of the moving element 6 by pivoting of the supports 19 about the first axes in clockwise direction, viewed from the right of the corresponding pick-up and moving device 4. The guiding device is then situated substantially in the extension of the pick-up element 5, as can be seen in FIG. 2. In this figure, the wall 13 is not represented, for the sake of clarity, but it will be readily understood that this wall 13 follows the movements of the small girders 18 and of the supports 19. In fact, the portion 13a of the wall 13 is articulated on the frame 17 about axes 27 visible in

FIG. 3. These axes 27 are placed immediately at the rear of the moving element 6. The portion 13a of the wall 13 follows, by pivoting about these axes 27, the movement of the supports 19 about the first axes 26. In addition, the other portion 13b of the wall 13 is held on the small girders 18 by links.

In this way, when the small girders 18 are moved from their active configuration towards their inactive configuration of FIG. 2, the overall dimension of the pick-up and moving device 4 in a direction perpendicular to the transporting surface of the conveyor 12 is clearly reduced.

The frame 17 of the pick-up and moving device 4 is connected to the chassis 1 of the machine by a connecting device 28. The latter enables the pick-up and moving device 4 to be transposed between a first substantially horizontal orientation (FIG. 1), used in particular in the work position of the machine, and a second orientation in which it is folded upwards (FIG. 2). To this end, the connecting device 28 comprises in particular a connecting arm 29 articulated on the chassis 1 and on the frame 17 of the pick-up and moving device 4. The connecting device 28 also comprises an axis 30 placed at the rear of the frame 17 and extending substantially parallel to the rotation axis 9 of the rotor 8. The connecting arm 29 is connected to the frame 17 by this axis 30. The small girders 18 being placed in the inactive configuration in which they are folded against the conveyor 12, the pick-up and moving device 4 can then be transposed from the first substantially horizontal orientation, which is also substantially transverse (FIG. 1), towards a substantially vertical and substantially transverse orientation, by pivoting upwards about the axis 30. The angle of this pivoting is, for example, close to 90° . In the substantially vertical and substantially transverse orientation, the small girders 18 extend on the rear of the pick-up and moving device 4. Then, by pivoting of the connecting arm 29 about a substantially vertical articulation axis 31 on the chassis 1, the pick-up and moving device 4 is folded, for example, towards the front. It is then situated in the second orientation which is substantially vertical and directed substantially in the direction of advance A, as can be seen in FIG. 2. The width of the machine is thus reduced. This second orientation is used in particular in the transport position of the machine.

The movements about the axes 26, 30 and 31 are operated by actuators, which are not shown, such as hydraulic or electric jacks or motors, for example. These actuators can be controlled from the tractor so that they carry out the different movements. With the aim of clarity, the preceding description relates to movements carried out one after the other. However, they can also, at least for some of them and/or over a portion of their respective movement ranges, take place simultaneously.

The machine according to the invention can comprise several pick-up and moving devices 4 placed side by side, with a view to increasing its working width. Thus, the machine illustrated in FIG. 1 comprises two lateral pick-up and moving devices 4 arranged on either side of the central beam of the chassis 1. This machine comprises in addition a central pick-up and moving device 4 placed beneath the central beam of the chassis 1. During work, these three devices 4 can, for example, be aligned so as to pick-up a continuous strip of fodder on the ground. Their respective moving elements 6 are then driven in the same direction so as to transfer the plants from one moving element 6 towards the adjacent moving element 6, for finally forming a windrow on the left side or else on the right side of the machine. It is also possible to work with the central pick-up and moving device lifted with a view to forming a single central windrow, or else one central windrow and one lateral windrow.

The machine according to the invention comprises at least one deflector 32 which cooperates with one of the pick-up and moving devices 4 so as to receive, during work, a flow of plants moved by the corresponding conveyor 12 so as to form a windrow. The machine, according to the example embodiment illustrated in FIGS. 1 and 2, comprises a first deflector 32 which cooperates with the left pick-up and moving device 4. It also comprises a second deflector 32 which cooperates with the right pick-up and moving device 4. The deflector 32 allows the formation of a regular and readily delimited windrow. When the plants present on the ground are picked up by the rotor 8 in an irregular flow due, for example, to variations in density or volume of the plants taken up by the rotor 8, the presence of the deflector at the side of the lateral end 38 of the conveyor 12 enables these plants, after having been moved by the conveyor 12, to fall on the ground again in a windrow, the great homogeneity of which facilitates its subsequent being taken up again by a baler or a chopper. These first and second deflectors 32, as well as their respective connecting means to the corresponding pick-up and moving devices 4, are substantially symmetrical to one another with respect to the central beam of the chassis 1. For this reason, the following description refers to the right deflector 32, but it is readily evident that it also concerns the left deflector 32, with an inversion of the terms “left” and “right” used in this description.

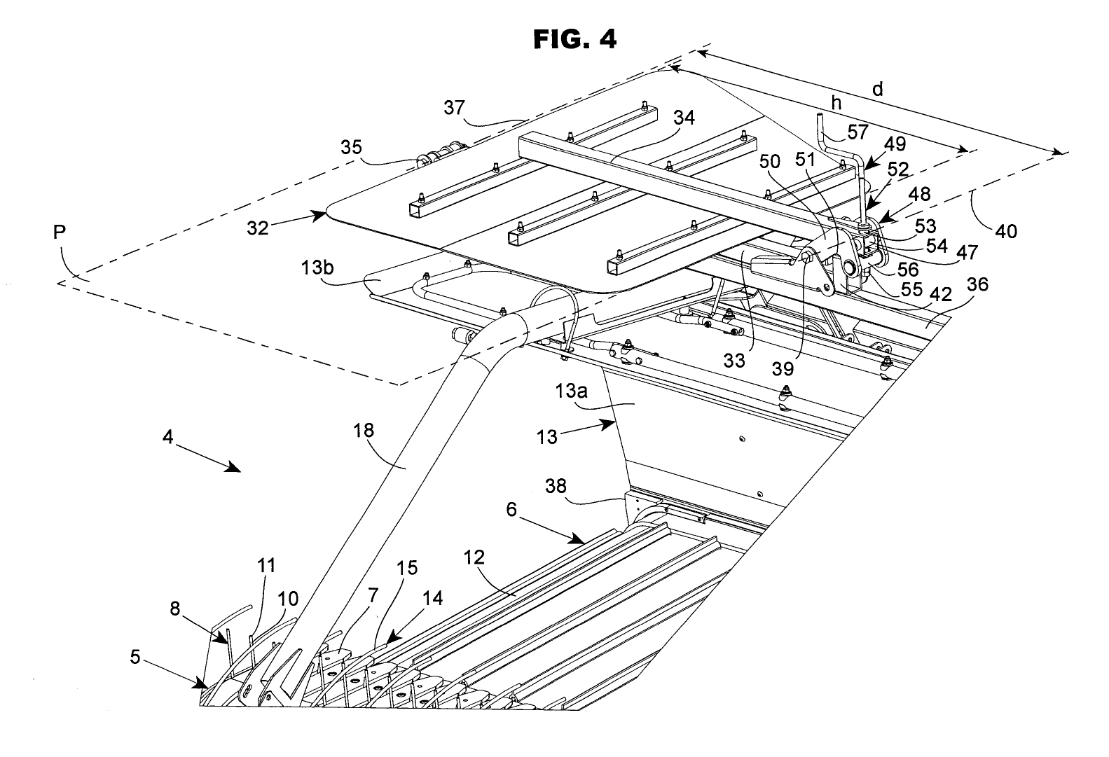

As illustrated in particular in FIG. 3, the deflector 32 is connected to an arm 33. The deflector 32 comprises a metal sheet or a cloth, which is preferably substantially flat. This metal sheet or cloth is held and made rigid by metallic strips, for example horizontal strips, connected to a tube 34 carried by the arm 33. This arm 33 is itself connected, by means of a first articulation device 58, to the pick-up and moving device 4, in this case to a small girder 18 of the pick-up and moving device 4. In this figure, the arm 33 is carried by the right small girder 18 viewed in the direction of advance A, by means of a tubular structure 36 connected to the small girders 18. This structure 36 extends above the pick-up element 5, in particular the rotor 8, and/or above the moving element 6, in particular the conveyor 12. This structure 36 carries the first articulation device 58. The first articulation device 58 comprises a first axis 35. The first articulation device 58 also comprises a first geometric pivoting axis 37 of the arm 33 with respect to the pick-up and moving device 4. According to the example embodiment of the figures, this first geometric pivoting axis 37 is concentric to the first axis 35. Preferably, the first geometric pivoting axis 37 is oriented, at least in the work position of the machine, substantially in the direction of advance A. By means of the first articulation device 58, the arm 33 can be pivoted, with respect to the pick-up and moving device 4, between a first position and a second position. According to the example embodiment, the pivoting of the arm 33, with respect to the pick-up and moving device 4, between the first position and the second position, is carried out about the first axis 35. In the first position illustrated in FIG. 3, the deflector 32 is arranged, in the work position of the machine, beside a lateral end 38 of the pick-up and moving device 4—in this figure, the right lateral end—and is remote from the lateral end 38. The lateral end 38 of the pick-up and moving device 4 corresponds to the lateral end of the conveyor 12. This first position of the arm 33 is used in the work position of the machine. In the second position of the arm 33 represented in FIG. 4, and considering the machine in the work position, the deflector 32 and the arm 33 extend substantially flat. In addition, they extend at least partially above the pick-up and moving device 4. This second position of the arm 33 can be used in the work position of the machine when the presence of the deflector 32 beside the conveyor 12 is not necessary for the formation of the windrow, or would pose a problem of overall dimension for the machine moving in a cramped environment. This second position of the arm 33 can also be used during manoeuvres, for example when the pick-up and moving device 4 carrying the deflector is folded upwards, at least partially, with a view to passing above an obstacle or a windrow which has already been formed. In this case, the folding of the arm 33 in the second position makes it possible to distinctly reduces the total width of the machine. In addition, the second position of the arm 33 is of great value in the transport position of the machine. In fact, when the pick-up and moving device 4 extends substantially to the horizontal, the second position of the arm 33 allows the arm 33 and the deflector 32 to occupy a reduced vertical overall dimension, namely very distinctly less than the total height of the pick-up and moving device 4. In this way, when the pick-up and moving devices 4 are then moved in their second orientation of FIG. 2, the total width of the machine is reduced. This advantage is further reinforced by the movement of the small girders 18 in their inactive configuration, in which they are folded against the conveyor 12.

As can be seen in particular from FIG. 4, in the second position of the arm 33, the deflector and the arm 33 extend substantially in the same plane P. Considering the machine in the work position, this plane P is substantially parallel to the ground.

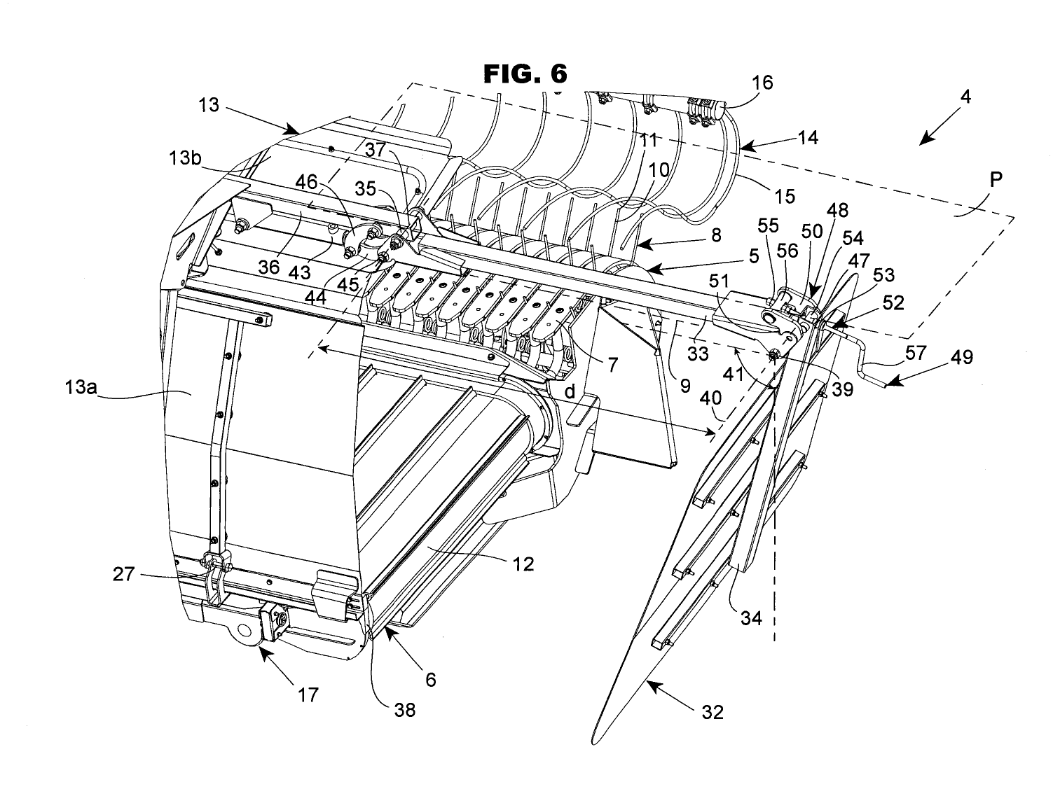

The first articulation device 58 is arranged in the vicinity of the lateral end 38 of the corresponding pick-up and moving device 4. In particular, the first geometric pivoting axis 37 is placed, along a direction parallel to the rotation axis 9 of the rotor 8, substantially at the level of the lateral end 38. This can be seen in particular from FIG. 6. In the first position, the arm 33 therefore extends substantially from the lateral end 38 in the direction of the deflector 32. Also in this first position, the arm 33 extends preferably substantially parallel to the rotation axis 9 of the rotor 8. In the work position of the machine, the arm 33 in the first position extends substantially parallel to the ground.

The arm 33 is articulated directly on the pick-up and moving device 4, in this case directly on the structure 36 carried by the small girders 18. This direct articulation of the arm 33 on the pick-up and moving device 4 is carried out by means of the first axis 35. As is apparent on examining FIGS. 3, 4 and 5, the first axis 35 may remain immobile with respect to the rotor 8 when the arm 33 is moved between the first position and the second position.

As can be seen from a comparison of FIGS. 3 and 4, the arm 33, with respect to the pick-up and moving device 4, is pivoted between the first position and the second position by an angle close to 180° about the first axis 35. In this way, the arm 33 in the second position extends between the lateral end 38 of the pick-up and moving device 4 and the opposite lateral end of this same device 4. In addition, the arm 33 extends substantially flat and above the tubular structure 36 on which it is articulated.

It can also be seen from FIGS. 3 and 4 that between the first position and the second position of the arm 33, the latter is pivoted in a plane transverse to the direction of advance A. In the example embodiment of the figures, this transverse plane is in particular substantially perpendicular to the direction of advance A of the machine. It could nevertheless be envisaged that when the pick-up and moving device 4 extends substantially to the horizontal, the first geometric pivoting axis 37 of the first articulation device 58 is inclined with respect to the direction of advance A. The arm 33 in the first position would then extend somewhat from the front to the back and would pivot in any transverse plane. It could also be envisaged that the pivoting of the arm 33 about the first geometric pivoting axis 37 is combined with a movement of the pick-up and moving device 4 between the first and second orientations and/or with a movement of the small girders 18 between the active and inactive configurations.

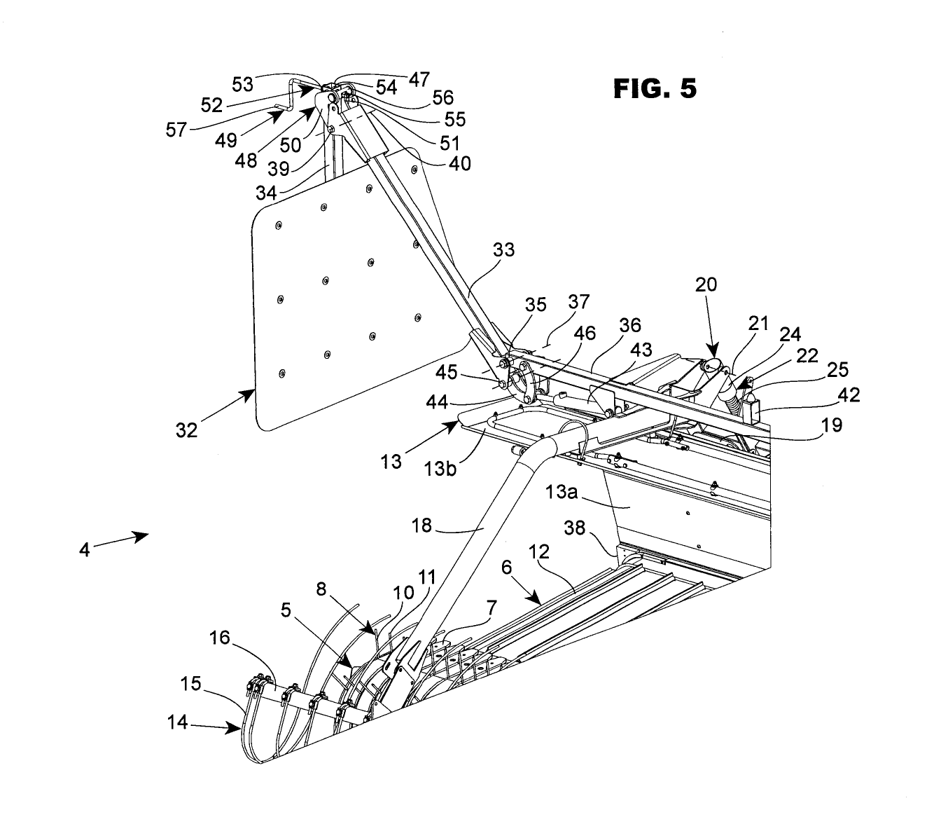

It can be seen in particular from FIG. 5 that the arm 33 is preferably pivoted upwards, about the first axis 35, from the first position towards the second position.

Apart from the first articulation device 58, the machine according to the invention comprises a second articulation device 59 connecting the deflector 32 to the arm 33. This second articulation device 59 comprises a second geometric pivoting axis 40. The latter is oriented, at least in the work position of the machine, substantially in the direction of advance A. The second articulation device 59 also comprises a second axis 39. According to the example embodiment of the figures, the second geometric pivoting axis 40 is concentric to the second axis 39.

The second articulation device 59 comprises an angular pivoting range 41, within which the deflector 32 can be folded against the arm 33 so that the deflector 32 extends substantially parallel to the arm 33. As can be seen in FIG. 3, this angular pivoting range 41 is close to 90°. In fact the deflector 32 can extend, in the first position of the arm 33, between a substantially vertical position and a substantially horizontal position, in which the deflector 32 is in abutment against the arm 33. In addition, in the second position of the arm 33 of FIG. 4, the deflector 32 rests on the arm 33, substantially parallel to the latter.

The invention advantageously makes provision that at least in the first position of the arm 33, the deflector 32 can pivot about the second axis 39 of the second articulation device 59, upwards and towards the lateral end 38 of the pick-up and moving device 4, towards the arm 33.

In addition, provision is made that within the angular pivoting range 41 previously described, the deflector 32 can pivot freely about the second axis 39. “Freely” is understood to mean in particular that the deflector 32 can, when it encounters an obstacle, pivot in the direction of the arm 33 so as to retract partially with respect to the obstacle. In addition, when the arm 33 is pivoted upwards from the first position, the deflector 32 pivots about the second axis 39 under the sole action of gravity, as is apparent in FIG. 5.

Advantageously, the invention therefore makes provision that the deflector 32 comes to rest against the arm 33, so as to extend substantially parallel to the arm 33, by free pivoting about the second axis 39, when the arm 33 is pivoted upwards from the first position towards a position situated beyond the vertical. This arrangement is economically advantageous, since means such as a jack or a motor are superfluous for folding the deflector 32 against the arm 33 by pivoting about the second axis 39.

In the second position of the arm 33 illustrated in FIG. 4, and considering the machine in the work position, the deflector 32 rests on a support 42 of the pick-up and moving device 4. This support 42 comprises, for example, a pad of elastomer material. This support 42 is rigidly fastened to the tubular structure 36 which extends above the small girders 18. Preferably, this support 42 is placed, with respect to the plane P, substantially at the same height as the first axis 35. This enables the arm 33 and the deflector 32 to extend substantially flat and at least partially above the pick-up and moving device 4, and to occupy a vertical overall dimension which is clearly smaller than the height of the pick-up and moving device 4.

As can be seen from FIG. 3, the invention advantageously makes provision that a distance d, separating the first and second axes 35 and 39, is greater than or equal to a height h of the deflector 32 placed in a position brought close to the vertical. Thus, it is prevented in particular that the deflector 32 goes past the lateral end 38 of the pick-up and moving device 4 when the arm 33 is placed in the second position of FIG. 4.

As can be seen from FIGS. 3 and 5, the arm 33 is pivoted about the first axis 35 by means of a jack 43. This jack 43 is double-acting. In the example embodiment of the figures it is hydraulic, but it can also be electric or pneumatic. Within the scope of the invention, provision can be made that the jack 43 is actuated at the same time as one or other of the actuators provided for carrying out the movements of the small girders 18 about the first axes 26 and/or of the pick-up and moving devices 4 about the axes 30 and 31.

The jack 43 is articulated, at one of its ends, on the pick-up and moving device 4, namely on the tubular structure 36. At its other end, the jack 43 is articulated on a slave lever 44 connected to the arm 33 by means of a third articulation 45 offset with respect to the first axis 35. Furthermore, a rod 46 is articulated between the slave lever 44 and the pick-up and moving device 4, namely the tubular structure 36 of the latter. This arrangement has a reduced overall dimension. It allows a pivoting of great amplitude of the arm 33 about the first axis 35 by means of a jack 43 of small length. In addition, the force exerted by the jack 43 is multiplied by the arrangement, hence the use of a jack 43 of reduced section. Finally, a straight line passing through the articulations of the jack never crosses the first axis 35, which prevents any risk of blocking of the arm 33 in an intermediate position between the first and second positions.

Once the arm 33 is pivoted in the second position, it remains held in this position by the double-acting jack 43. In addition, as can be seen from FIG. 4, the deflector 32 rests on the support 42 of the pick-up and moving device 4 by means of an upper end 47 of the tube 34 of the deflector 32. This upper end 47 somewhat goes past the second axis 39. Thus, in the second position of the arm 33, the deflector 32 can not pivot about the second axis 39. This arrangement prevents the deflector 32, in particular during manoeuvres or transport of the machine, from coming to rock inadvertently.

In the first position of the arm 33 of FIG. 3, the deflector 32 is, by its own weight, resting against the arm by means of an abutment means 48 placed between the deflector 32 and the arm 33.

Apart from the abutment means 48, an adjustment means 49 is provided of the pivoted position of the deflector 32 with respect to the arm 33, about the second axis 39. This adjustment means 49 is placed in operational manner between the deflector 32 and the arm 33.

As is apparent in further detail in FIG. 6, the abutment means 48 comprises a lever 50 articulated on the arm 33 in the vicinity of the second axis 39. The second axis 39 is in this case common to the deflector 32 and to the lever 50. This lever 50 is connected to the deflector 32 by means of the adjustment means 49. In addition, the lever 50 comprises a face 51 designed to rest against the end of the arm 33 close to the second axis 39 when the arm 33 is in the first position. In this case, the deflector 32 can extend in particular in a substantially vertical position. In addition, it is apparent in FIG. 6 that the adjustment means 49 allows the deflector 32 to be oriented in a partially folded position towards the arm 33 when the latter extends in the first position. To this end, the adjustment means 49 comprises in particular a shaft 52. The latter is in helicoidal connection with the upper end 47 of the tube 34 of the deflector 32. The shaft 52 comprises a threaded part 53 which cooperates with a tapped axis 54 connected to the upper end 47 of the tube 34. The helicoidal connection is oriented perpendicularly to the second geometric pivoting axis 40 of the second articulation device 59. The threaded part 53 of the shaft 52 comprises another end 55 which cooperates with the arm 33 or the lever 50. In the example embodiment of the figures, this other end 55 passes through an axis 56 carried by the lever 50. In addition, this other end 55 carries two pairs of nuts placed on either side of the said axis 56. The other end 55 of the threaded part 53 is therefore in pivot connection with the axis 56. In this way, a rotation of the shaft 52 brings about a movement of the deflector 32 with respect to the lever 50, by pivoting of the deflector 32 about the second axis 39. Given that in the first position of the arm 33, the lever 50 is resting against the latter at the level of the face 51, the rotation of the shaft 52 involves a pivoting of the deflector 32 in the direction of the arm 33 about the second axis 39. An identical effect could also be obtained in the case in which the other end 55 of the shaft 52 were to cooperate directly with the arm 33. The deflector 32 is thus placed in a position closer to the lateral end 38 of the pick-up and moving device 4. Such an adjustment allows the width of the windrow formed by the machine according to the invention to be adapted to the conditions of picked up fodder and to the parameters of another machine which is to subsequently take up the formed windrow again. In the example embodiment of the figures, the shaft 52 is rigidly fastened to a handle 57. The latter enables the user of the machine to operate the rotation of the shaft 52 manually. It could also be envisaged to connect the shaft 52 to a remote control means, such as a hydraulic or electric motor, so as to guide the position of the deflector 32 from a control unit placed on the machine or permanently on the tractor.

It is readily evident that the invention is not limited to the example embodiment described above and represented in the attached figures. Modifications remain possible, in particular with regard to the constitution or the number of the various elements or by substitution of technical equivalents without, however, departing from the scope of protection.

What is claimed as new and desired to be secured by Letters Patent of the United States is:

1. A haymaking machine comprising at least one plant pick-up and moving device, comprising a rotor able to be driven about a rotation axis which is substantially horizontal and substantially perpendicular to a direction of advance of the machine in a work position, teeth with teeth points describing a curve envelope when the rotor is driven about the rotation axis, and a conveyor which moves the plants transversely to the direction of advance, the machine also comprising at least one deflector which cooperates with the pick-up and moving device so as to receive, during work, a flow of plants moved by the conveyor so as to form a windrow, the deflector being connected to an arm which is itself connected, by means of a first articulation device, to the pick-up and moving device, by means of which first articulation device the arm can be pivoted, with respect to the pick-up and moving device, between a first position in which the deflector is arranged, in the work position of the machine, beside a lateral end of the pick-up and moving device and is remote from the lateral end, and a second position, wherein in the second position of the arm and considering the machine in the work position, the deflector and the arm extend substantially flat and at least partially above the pick-up and moving device.

2. The haymaking machine according to claim 1, wherein in the second position of the arm, the deflector and the arm extend substantially in a same plane which, considering the machine in the work position, is substantially parallel to the ground.

3. The haymaking machine according to claim 1, wherein the first articulation device comprises a first axis, by means of which the arm is articulated directly on the pick-up and moving device, and wherein the first axis may remain immobile with respect to the rotor when the arm is moved between the first position and the second position.

4. The haymaking machine according to claim 1, wherein the first articulation device comprises a first axis about which the arm is pivoted, with respect to the pick-up and moving device, between the first position and the second position by an angle close to 180°.

5. The haymaking machine according to claim 1, wherein between the first position and the second position of the arm, the arm is pivoted in a plane transverse to the direction of advance.

6. The haymaking machine according to claim 1, wherein the first articulation device comprises a first axis, about which the arm is pivoted upwards from the first position towards the second position.

7. The haymaking machine according to claim 1, wherein the deflector is connected to the arm by means of a second articulation device.

8. The haymaking machine according to claim 7, wherein the second articulation device comprises an angular pivoting range within which the deflector can be folded against the arm so as to extend substantially parallel to the arm.

9. The haymaking machine according to claim 7, wherein at least in the first position of the arm, the deflector can pivot about a second axis of the second articulation device, upwards and towards the lateral end, towards the arm.

10. The haymaking machine according to claim 8, wherein within the angular pivoting range, the deflector can freely pivot about the second axis.

11. The haymaking machine according to claim 7, wherein the deflector comes to rest against the arm, so as to extend substantially parallel to the arm, by free pivoting about a second axis of the second articulation device, when the arm is pivoted upwards from the first position towards a position situated beyond the vertical.

12. The haymaking machine according to claim 2, wherein the first articulation device comprises a first axis, about which the arm can pivot with respect to the pick-up and moving device, and wherein, in the second position of the arm and considering the machine in the work position, the deflector rests on a support of the pick-up and moving device placed, with respect to the plane, substantially at the same height as the first axis.

13. The haymaking machine according to claim 7, wherein the first and second articulation devices comprise geometric pivoting axes oriented, at least in the work position of the machine, substantially in the direction of advance.

14. The haymaking machine according to claim 1, wherein the first articulation device comprises a first axis, about which the arm can pivot with respect to the pick-up and moving device, and wherein the arm is pivoted about the first axis by means of a jack articulated on the pick-up and moving device and on a slave lever connected to the arm by means of a third articulation offset with respect to the first axis, and wherein in addition a rod is articulated between the slave lever and the pick-up and moving device.

15. The haymaking machine according to claim 1, wherein in the first position of the arm, the deflector is, by its own weight, resting against the arm by means of an abutment means placed between the deflector and the arm.

16. The haymaking machine according to claim 7, wherein an adjustment means of the pivoted position of the deflector with respect to the arm, about a second axis of the second articulation device, is placed in operational manner between the deflector and the arm.

17. The haymaking machine according to claim 1, wherein the pick-up and moving device comprises a frame and at least one small girder carrying the arm connected to the deflector, wherein the small girder is articulated on the frame by means of a moving device comprising at least a first axis substantially parallel to the rotation axis of the rotor, about which first axis the small girder can be pivoted between an active configuration and an inactive configuration, in which the small girder is folded against the conveyor.

18. The haymaking machine according to claim 1, wherein a frame of the pick-up and moving device is connected to a chassis of the machine by a connecting device, by means of which the pick-up and moving device can be transposed between a first substantially horizontal orientation and a second orientation in which it is folded upwards.
